(19) United States
(12) Patent Application Publication
(10) Pub. No.: US 2025/0105239 A1
(43) Pub. Date: Mar. 27, 2025

(54) FOAMED ELECTRODE STRUCTURE

(71) Applicant: UT-Battelle, LLC, Oak Ridge, TN (US)

(72) Inventors: Beth L. Armstrong, Oak Ridge, TN (US); Meghan Lamm, Oak Ridge, TN (US); Nitin Muralidharan, Knoxville, TN (US); Marm Dixit, Oak Ridge, TN (US); Gabriel M. Veith, Knoxville, TN (US); Khryslyn Arano, Oak Ridge, TN (US)

(21) Appl. No.: 18/371,782

(22) Filed: Sep. 22, 2023

(51) Int. Cl. H01M 4/04; H01M 4/02; H01M 4/131; H01M 4/134; H01M 4/1391; H01M 4/1395; H01M 4/38; H01M 4/525; H01M 4/62; H01M 4/66; H01M 10/0525

(52) U.S. Cl. CPC H01M 4/0404; H01M 4/0471; H01M 4/131; H01M 4/134; H01M 4/1391; H01M 4/1395; H01M 4/386; H01M 4/525; H01M 4/622; H01M 4/625; H01M 4/661; H01M 10/0525; H01M 2004/021

(57) ABSTRACT

The disclosure is to method for making a foamed battery electrode, both anode and cathode, for use in, e.g. a lithium ion battery. The electrode has improved porosity and interconnectedness. The disclosure is also directed to the foamed electrode and a lithium ion battery comprising same.

### STATEMENT REGARDING FEDERALLY SPONSORED RESEARCH

The United States Government has rights in this invention pursuant to contract no. DE-AC05-00OR22725 between the United States Department of Energy and UT-Battelle, LLC.

### FIELD

The disclosure relates to a foamed battery electrode useful in e.g. lithium ion batteries, the foamed electrode having an intracellular porosity sufficient to facilitate fast ion transport and volume expansion during cycling of alkali ions (e.g. lithium ions) or the infiltration of secondary phases.

### BACKGROUND

Control of electrode architecture and organization in batteries such as lithium ion batteries to improve battery performance, stability and calendar life has been a challenge for battery chemistries as material energy densities increase from traditional graphite electrodes (capacity of 330 mAh/g) to materials like silicon (˜3600 milli-amp hours/gram (mAh/g), tin, antinomy, phosphorous, and mixtures thereof. In addition, materials like silicon (Si) undergo large expansion during cycling causing mechanical stresses on the electrode, closure of pores, and mechanical collapse which prevents intercalation of alkali ions such as lithium and sodium in the electrode. Controlled porosity approaches have been proposed utilizing sacrificial or fugitive phase that are insoluble in the battery electrode slurry which are subsequently removed via a chemical approach such as solution dissolution, or a thermal approach where the phase decomposes and volatizes, leaving behind a pore. This approach results in an intercellular framework where interconnection between the porous network is dependent upon dispersion in the electrode slurry and concentration of the fugitive phase. Invariably, the pores are not interconnected and although improvements are seen in electrochemical performance still may result in orphaned porosity and slow or minimized diffusion of ion transport.

Moreover, challenges involving composite cathodes for solid-state batteries revolve around achieving efficient ion and electron transport within the cathode materials, which is crucial for the overall performance of the battery. As battery chemistries move to from liquid electrolytes wherein the diffusion of the electrolyte through the electrode is dependent upon the electrode architecture, to a solid state battery approach, the benefits of a composite architecture are crucial, utilizing a porous intracellular scaffold to support a more conductive secondary phase (like an antiperovskite) to achieve thicker, cathode architectures. Further, scaling up the production of composite cathodes with consistent properties can be challenging. Maintaining the desired microstructure and composition across large-scale manufacturing processes is essential for commercial viability. Addressing these challenges is critical to realizing the full potential of solid-state batteries, as the cathode plays a pivotal role in determining the overall performance, safety, and longevity of these advanced energy storage devices.

Foaming agents are common additives used in the polymer and film industries to produce large, bulk insulation. Foaming agents are generally separated into two types. One being a surfactant, the other being a blowing agent. A surfactant, when present in small amounts, reduces the surface tension of a liquid (reduces the energy needed to create the foam) or increases its colloidal stability by inhibiting coalescence of bubbles. Examples include sodium lauryl ether sulfate, sodium dodecyl sulfate, or ammonium lauryl sulfate. A blowing agent is a gas that forms the gaseous part of the foam. Blowing agents can be again separated into two types: chemical and physical. Physical blowing agents exist as a gas at the temperature the foam is formed, for example, CO2, pentane and chloroflourocarbons, while chemical blowing agents produce gases as a result of a chemical reaction, such as sodium bicarbonate (baking soda), azodicarbonamide, titanium hydride and isocyanates with water. However, this approach has not been used to fabricate thin or thick film structures, such as present in batteries, partly due to the complexity of battery chemistries, and the negative impact of additives on battery performance.

### SUMMARY

In one aspect, the disclosure is directed to a method for making a foamed battery electrode comprising: (i) providing a slurry comprising a binding agent, a solvent, an electrode component, a conductive additive, and a foaming agent; (ii) casting the slurry onto a current collector; (iv) removing the solvent; and (v) heating the result of (iv) to cure the binder and obtain a foamed battery electrode. In one practice, the foaming agent comprises thermoplastic microspheres which contain a gas. The thermoplastic of the thermoplastic microspheres has a melt temperature less than the heat curing temperature of step (v), and wherein after step (v), the thermoplastic microspheres and the gas contained therein are substantially removed from the foamed battery electrode, the removal leaving behind pores therein.

In other aspects, the disclosure is variously directed to a foamed battery electrode made by the method herein; a lithium ion battery comprising a foamed battery electrode made by the method herein.

### BRIEF DESCRIPTION OF THE DRAWINGS

FIG. 1 is a schematic showing the formation of gas pockets during heat treatment according to the disclosure.

FIG. 2 is a flow chart of an embodiment of a method of making a foamed Si anode of the disclosure.

FIG. 3 is a scanning electron microscope (SEM) of a representative surface image of a foamed electrode of the disclosure prepared with a foaming agent.

FIG. 4 (Left) is a scanning electron microscope (SEM) surface image of an embodiment of a silicon electrode of the disclosure prepared with 1 wt % of a first foaming agent, Agent X, as defined herein. (Right) is a scanning electron microscope surface image of the same silicon electrode at a higher magnification.

FIG. 5 (Left) is a scanning electron microscope surface image of an embodiment of a silicon electrode of the disclosure prepared with 3 wt % of a first foaming agent, Agent X. (Right) is a scanning electron microscope surface image of the same silicon electrode at higher magnification.

FIG. 6 (Left) is a scanning electron microscope surface image of an embodiment of a silicon electrode of the disclosure prepared with 5 wt % a first foaming agent, Agent X. (Right) is a scanning electron microscope surface image of the same silicon electrode at higher magnification.

FIG. 7 (Left) is a scanning electron microscope surface image of an embodiment of a silicon electrode of the disclosure prepared with 1 wt % a first foaming agent, Agent X. (Right) is a scanning electron microscope surface image of the same silicon electrode prepared with 7 wt % of a first foaming agent at higher magnification.

FIG. 8 is a scanning electron microscope surface image of the metal-decorated silicon (Si^{M}) electrode without a foaming agent.

FIG. 9 (Left) is a scanning electron microscope surface image of the metal-decorated silicon (Si^{M}) electrode with 3 wt % of a first foaming agent, Agent X. (Right) is a scanning electron microscope surface image of the same silicon electrode at higher magnification.

FIG. 10 is a scanning electron microscope surface image of the metal-decorated silicon (Si^{M}) electrode with 3 wt % of a second foaming agent, Agent Y, as defined herein. (Right) is a scanning electron microscope surface image of the same silicon electrode at higher magnification.

FIG. 11 is a graph of specific lithiation capacity (mAh g_{Si}⁻¹) of four foamed Si electrodes with varying amounts of a first foaming agent, Agent X, as a function of cycle number. The cells were cycled in half-cell configuration using coin cells and using Li metal as a counter electrode and 1.2 M LiPF₆ in 3/7 w/w ethylene carbonate/ethyl methyl carbonate as the electrolyte. Cycling was performed in galvanostatic mode with a voltage window of 0.05 V and 1 V and a cycling rate of C/20 for the formation steps (performed 3 times) and C/10 for long-term cycling. Data were measured at room temperature.

FIG. 12 is a graph of specific lithiation capacity (mAh·g_{Si}⁻¹) of the foamed Si electrodes with varying amount of a first foaming agent, Agent X, at different current densities ranging from 179 mA g⁻¹ to 7 Ah g⁻¹. The cells were cycled in half-cell configuration using coin cells and using Li metal as a counter electrode and 1.2 M LiPF₆ in 3/7 w/w ethylene carbonate/ethyl methyl carbonate as the electrolyte. Cycling was performed in galvanostatic mode with a voltage window of 0.05 V and 1 V. Data were measured at room temperature.

FIG. 13 is a graph of specific lithiation capacity (mAh·g_{Si}⁻¹) of the foamed metal-decorated Si electrodes with 3 wt % of a first foaming agent, Agent X, and 3 wt % of a second foaming agent Y compared to the non-foamed metal-decorated silicon as a function of cycle number. The cells were cycled in half-cell configuration using coin cells and using Li metal as a counter electrode and 1.2 M LiPF₆ in 3/7 w/w ethylene carbonate/ethyl methyl carbonate as the electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

FIG. 14 are Nyquists plot of the half cells prepared from the foamed silicon electrodes with 1 wt %, 3 wt %, 5 wt %, and 7 wt % of a first foaming agent, Agent X, obtained at delithiated states after the formation steps at C/20.

FIG. 15 are Nyquist plots of the half cells prepared from the foamed silicon electrodes with 1 wt %, 3 wt %, 5 wt %, and 7 wt % of a first foaming agent, Agent X, obtained at delithiated states after the formation steps at C/20 as presented in FIG. 14, with FIG. 15 focusing on the high (10 KHz) to mid (˜35 kHz) frequency region.

FIG. 16 are Nyquist plots of the half cells prepared from the foamed silicon electrodes with 1 wt %, 3 wt %, 5 wt %, and 7 wt % of a first foaming agent, Agent X, obtained at delithiated states after 20 cycles at C/3.

FIG. 17 are Nyquist plots of the half cells prepared from the foamed silicon electrodes with 1 wt %, 3 wt %, 5 wt %, and 7 wt % of a first foaming agent, Agent X, obtained at delithiated states after 20 cycles at C/3 as presented in FIG. 16, with FIG. 17 focusing on the high (10 KHz) to mid (˜35 kHz) frequency region.

FIG. 18 are Nyquist plots of the half cells prepared from the foamed metal-decorated silicon (Si^{M}) electrodes without a foaming agent, and with 3 wt % of a first foaming agent, Agent X, and 3 wt % of a second foaming agent, Agent Y, respectively, obtained at delithiated states after the formation steps at C/20.

FIG. 19 are Nyquist plots of the half cells prepared from the foamed metal-decorated silicon (Si^{M}) electrodes without a foaming agent, and with 3 wt % of a first foaming agent, Agent X, and 3 wt % of a second foaming agent, Agent Y, obtained at delithiated states after the formation steps at C/20 as presented in FIG. 18, with FIG. 19 focusing on the high (10 KHz) to mid (˜35 kHz) frequency region.

FIG. 20 are Nyquist plots of the half cells prepared from the foamed metal-decorated silicon (Si^{M}) electrodes without a foaming agent, and with 3 wt % of a first foaming agent, Agent X, and 3 wt % of a second foaming agent, Agent Y, obtained at delithiated states after 20 cycles at C/3.

FIG. 21 are Nyquist plots of the half cells prepared from the foamed metal-decorated silicon (Si^{M}) electrodes without a foaming agent, and with 3 wt % of a first foaming agent, Agent X, and 3 wt % of a second foaming agent, Agent Y, obtained at delithiated states after 20 cycles at C/3 as presented in FIG. 18, with FIG. 21 focusing on the high (10 KHz) to mid (˜35 kHz) frequency region.

FIG. 22(a) is surface scanning electron microscope image of a foamed cathode of the disclosure comprising an antiperovskite (LiOHBr) that was melt-infiltrated over it; the foaming agent was Agent X used at 5 wt %. FIG. 22(b) is the same as FIG. 22(a) only the foaming agent, Agent X, was used at 10 wt %.

FIG. 23(a) is surface scanning electron microscope image of a foamed cathode of the disclosure comprising an antiperovskite (LiOHCl) that was melt-infiltrated over it; the foaming agent was Agent X used at 5 wt %. FIG. 23(b) is the same as FIG. 23(a) only the foaming agent, Agent X, was used at 10 wt %.

FIG. 24(a) is surface scanning electron microscope image of a foamed cathode of the disclosure comprising an antiperovskite (LiOHClBr) that was melt-infiltrated over it; the foaming agent was Agent X used at 5 wt %. FIG. 24(b) is the same as FIG. 24(a) only the foaming agent, Agent X, was used at 10 wt %.

FIG. 25 is surface scanning electron microscope image of a foamed cathode of the disclosure comprising an antiperovskite (LiOHCl) that was melt-infiltrated over it; the foaming agent was Agent X used at 5 wt %. FIG. 25(b) is the same as FIG. 25(a) only the foaming agent, Agent X, was used at 10 wt %.

### DETAILED DESCRIPTION

As used herein terms such as “a,” “an,” and “the” are not intended to refer to only a single entity but include the general class of which a specific example may be used for illustration. Terms defined herein in the singular are intended to include those terms defined in the plural and vice versa.

Reference to any numerical range as used herein expressly includes each numerical value (including fractional numbers and whole numbers) encompassed by that range and includes the endpoints of that range. For illustrative purposes only, a reference to a range of “0.0001 to 5000” includes whole numbers such as 5000, 4999, 4998 . . . 3, 2, 1; and includes fractional numbers such as 0.00011, 0.00012 . . . 0.1, 0.2, 0.3 . . . 1.1, 1.2, 1.3 . . . 100.5, 100.6 . . . 4900.5, 4990.6, 4990.7 etc.

As used herein, the term “about” includes the value listed and indicates that the value listed may be somewhat altered, as long as the alteration does not result in nonconformance of the article or method or system herein described. For example, the term “about” as used herein can refer to a variation of between ±1% up to ±10%, including any value therebetween.

As used herein, the term “substantially,” or “substantial,” is equally applicable when used in a negative connotation to refer to the complete or near complete lack of an action, characteristic, property, state, structure, item, or result. For example, a surface that is “substantially” flat would either [be] completely flat, or so nearly flat that the effect would be the same as if it were completely flat.

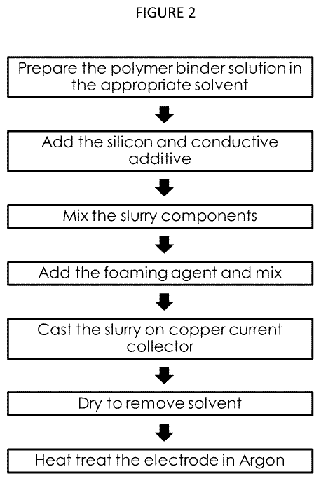

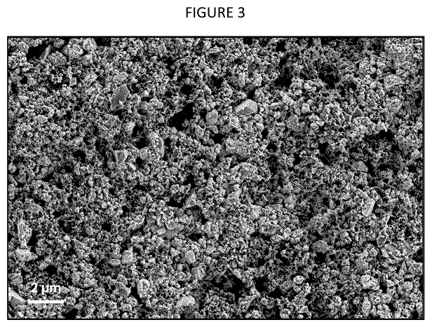

In one aspect, the disclosure is directed to a method for making a foamed battery electrode comprising (i) providing a slurry comprising a binding agent, a solvent, an electrode component, a conductive additive, and a foaming agent; (ii) casting the slurry onto a current collector; (iv) removing the solvent; and (v) heating the result of (iv) to cure the binder and obtain a foamed battery electrode. One practice of the method is shown in the flow chart in FIG. 2, directed to an embodiment of a foamed anode (comprising silicon) of the disclosure. FIG. 3 is a scanning electron microscope (SEM) of a representative surface image of a foamed electrode of the disclosure prepared with a foaming agent. It will be understood that the singular terms “a binding agent,” “a solvent,” “an electrode component,” “a conductive additive,” and “a foaming agent” includes one or more binding agents, solvents, electrode components, conductive additives, and foaming agents, which may be the same or different in each respective case.

In one practice, the slurry is prepared by first combining the binding agent and the solvent, followed by then adding the electrode component and the conductive additive to the combination. To the slurry thus formed (the slurry comprising the binding agent, the solvent, the electrode component, and the conductive additive) the foaming agent is added. Optionally, the slurry can of (i) further comprises a redox active material as known in the art, such as graphite.

The binding agent comprises those known in the art such as one more polymer binders, e.g. a polyimide binder, such as P84 type poluimide binder. The solvent comprises one or more of those known in the art, and include dielectric solvents, e.g. N-methyl pyrollidone NMP), water, ethanol, dimethyl formamide, xylene, or mixtures of any of the foregoing.

The electrode component can comprise one or more anode components or one or more cathode components each as known in the battery art, including those used for lithium ion batteries. Without limitation, the anode component can comprise one or more of graphite, Si (silicon), Sn (tin), Cu₂Sb, Mo₃Sb₇, Sb (antimony), Cu₆Sn₅, Al (aluminum), Pt (platinum), Au (gold), and In (indium) including any combination of the foregoing. In one instance, and without limitation, the cathode component can be comprised of nickel, manganese, and cobalt. In various practices, the cathode component cathode can comprise one or more of LiNi1/3Mn1/3Co1/3O2, LiCoO2, Li(CoAl)1O2, Li1.2(MnNiCo)0.8O2, LiMn2O4, Li2MnO3, LiMn1.5Ni0.5O4, LiFePO4, LiCoPO4, LiNiPO4, LiNiO2, Li—V—O, Li2Si—Mn, Fe, Ni—O4, NaFeO2, NaCrO2, Na(Fe,Mn,Ni,Co)O2, and Na2(Ni,Fe,Mn)O4.

The conductive additive comprises one or more of those known in the art, e.g. carbon black. The current collector comprises a suitable metal as known in the art e.g. the current collector can comprise copper when the electrode component is an anode component, and can comprise aluminum when the electrode component is a cathode component.

In one practice, the foaming agent comprises thermoplastic microspheres, where the thermoplastic microsphere shell encapsulates a gas, such as a hydrocarbon gas. In one instance, the thermoplastic of the thermoplastic microspheres has a melt temperature less than the heat curing temperature of step (v), and wherein after step (v), the thermoplastic microspheres and the gas contained therein are substantially removed from the foamed battery electrode, the removal leaving behind pores therein. When heated, as in the curing step (iv), the gas expands while the thermoplastic shell softens, giving a large increase in volume. In one practice, the thermoplastic microspheres can be in the form of a dry powder and can be directly added to the slurry. Thermoplastic microspheres include those known in the art, e.g. EXPANCEL 980 DU 120 microspheres commercially available from Akzo Nobel (referred to herein as either “Agent X” or the “first foaming agent”) which consist of a thermoplastic polymer shell encapsulating a gas. When heated, the internal pressure from the gas increases and the thermoplastic shell softens, resulting in a dramatic increase of the volume of the microsphere; and/or EML101 ADVANCELL commercially available from Sekisui (referred to herein as either “Agent Y” or the “second foaming agent.”) which comprises of a thermally-expandable acrylic shell containing a low-boiling-point liquid hydrocarbon inside the thermoplastic polymer shell. When heated, the shell softens and the hydrocarbon inside suddenly expands, forming micro-balloons. The thermoplastic microspheres as used herein can be used individually or combined.

During this heat treatment, curing step (iv), a substantial portion of the thermoplastic shell of the microsphere is decomposed, e.g. burned off, leaving behind its porous architecture and preventing any contamination of the battery chemistry. Porosity in this regard can be controlled by ratio of foaming agent to the active materials and/or by the reaction time. For example, the more foaming agent, the greater the porosity and the larger the pore size.

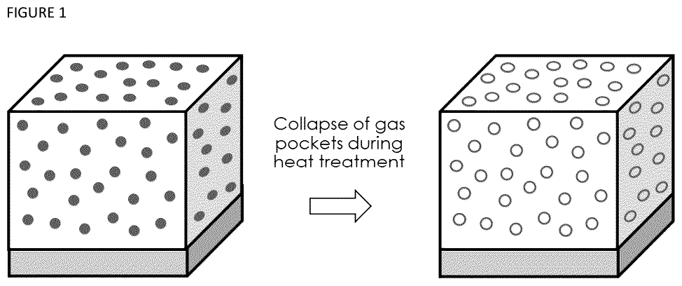

Moreover, in certain practices, the solubility of the microspheres with in various solvents employed in the method in (i) e.g. N-methyl pyrollidone, the thermoplastic shell will immediately begin to soften and some foaming will thus begin. The time between addition of the foaming agent addition and casting in step (ii) will dictate the pores size, pore ligament thickness and distribution. A foaming agent that is insoluble, such as sodium bicarbonate, is dependent upon the level of dispersion in the slurry. In one practice, a poorly dispersed foaming agent will settle to the top or bottom of the electrode after casting (density and size dependent) and will create a graded porosity structure after heat treatment; this will enable further control of the architecture of the pore structure. Since chemical blowing agents fully decompose into gases, they will not contaminate the complex battery chemistry. The porosity of the foamed electrode can be tailored by modifying the concentration of the foaming agent. FIG. 1 is a schematic showing the representative formation of gas pockets leading to the porosity during heat treatment according to the disclosure.

When the electrode component is a cathode component, the method can further comprise a step of infiltrating the foamed battery cathode resulting from step (v) with a secondary conductor. It will be understood that the singular term “a secondary conductor” includes one or more secondary conductors which may be the same or different. Secondary conductors in this regard include those known in the art, e.g. solid electrolytes such as known antiperovskite electrolytes and other known secondary conductors such as those comprising other lithium salts; in one instance the antiperovskite electrolytes have the formula Li₂OHX, where X is a halide such as Cl, Br, and the like. In another aspect, the disclosure is directed to a foamed battery electrode (anode or cathode) made by the method herein. In another aspect, the disclosure is directed to a battery, such as a lithium ion battery comprising a foamed battery electrode made by the method herein. In one practice, such a lithium ion battery comprises a foamed anode and/or a foamed cathode as made by the method herein and comprises other battery components as known in the art, e.g. a separator, an electrolyte and the like.

With the foamed electrode, coupled with antiperovskite solid electrolytes (Li₂OHX, X=Cl, Br, etc.), modulation of crystallization behavior after melt-infiltrating the solid electrolyte within the interconnected pores is achievable. Depending on the chosen halide group (e.g., chloride, bromide, or combination thereof), distinct crystallization morphologies within the foamed cathode materials post-infiltration can be obtained. These varying morphologies wield significant influence over ion transport and, consequently, the overall performance of the battery.

### EXAMPLE 1

Various foamed anodes were prepared as follows pursuant to the method of the disclosure:

Percentages (%) are in wt % unless otherwise indicated. The silicon electrodes were fabricated using a weight ratio of 80% silicon, 10% carbon black (C45), and 10% polyimide binder (P84). The polyimide binder was pre-dissolved in n-methyl pyrrolidone (NMP) solvent in 10 wt % ratio of P84 in NMP. The binder solution and excess NMP for viscosity adjustment were placed in a mixing jar with the mixing media, followed by the addition of the solid components. The electrode components were mixed using a low energy mixer until a homogeneous slurry is obtained. The foaming agent was added in 1%, 3%, 5%, and 7 wt % concentration and mixed with the slurry. The slurry with the foaming agent was cast onto a copper current collector and dried until the NMP solvent is removed. The prepared electrodes were heated treated in argon at 350° C. for one hour to cure the polyimide binder. As seen in the Figures herein for the anode, increases in the amount of foaming agent, increased the yield of pores based on the SEM images.

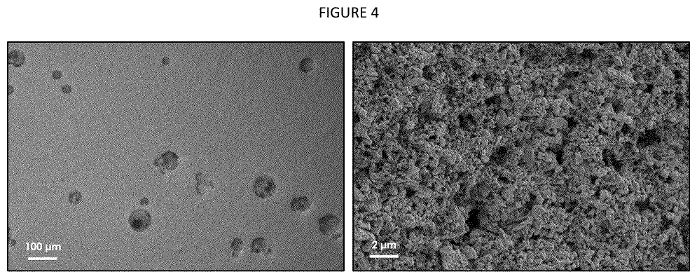

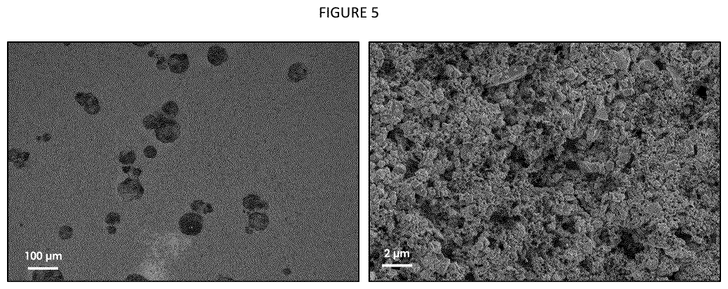

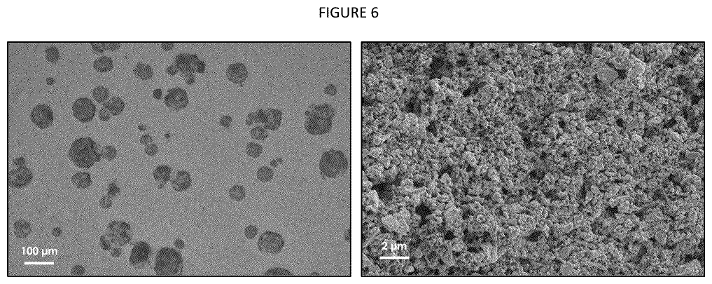

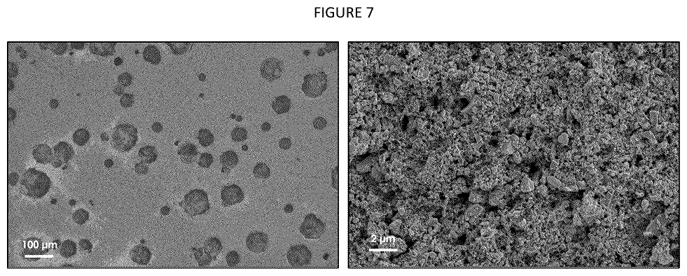

FIGS. 4, 5, 6, and 7 show the surface scanning electron microscope images of the silicon electrode cured at 350° C. in argon for 1 hour with different concentrations of the first foaming agent. The images show the porosity in the electrodes formed during heat treatment as a result of the collapsing of the gas pockets generated by the foaming agent. The images show the increasing degree of porosity as the concentration of first foaming agent is increased from 1% to 7%. The magnified images (Right) in FIGS. 4, 5, 6, and 7 show the characteristic pores of the electrodes that are present even without the foaming agent as presented in FIG. 3. The pores generated by the first foaming agent had a heterogenous size distribution which vary from 20 μm to 100 μm as presented in FIGS. 4, 5, 6, and 7 (Left).

The foamed silicon electrodes were incorporated into a half cell configuration battery using lithium metal as the counter electrode. The cells were cycled 3 times at C/20 (full lithiation/delithiation over 20 hours) followed by longer cycling at C/10 (full lithiation/delithiation over 10 hours). Rate tests were also performed by varying the current C-rates including C/20, C/10, C/5, C/3, C, and 2C, equivalent to 179 mA g⁻¹, 358 mA g⁻¹, 716 mA g⁻¹, 1.2 Ah g⁻¹, 3.6 Ah g⁻¹, and 7.2 Ah g⁻¹, respectively.

Electrodes were also prepared by changing the anode from silicon to metal-decorated silicon (Si^{M}) the second foaming agent. The electrodes were prepared following the procedure outlined in FIG. 2.

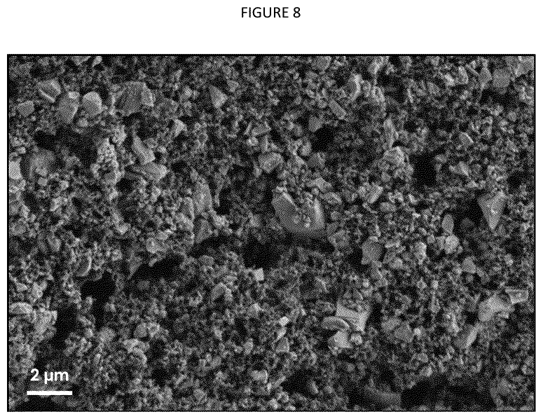

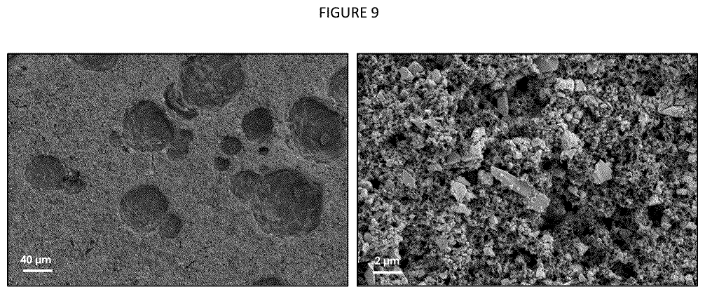

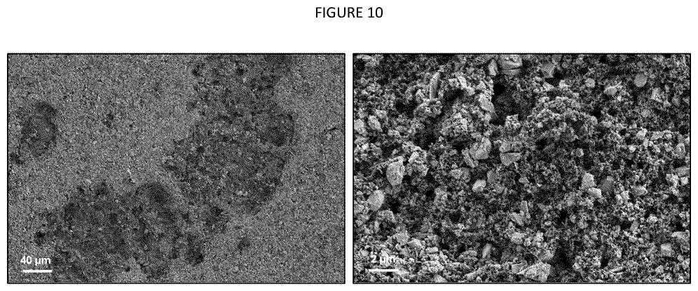

FIGS. 8, 9, and 10 present the surface scanning electron microscope images of the non-foamed Si^{M}, Si^{M} with 3% of the first foaming agent, and Si^{M} with 3% of the second foaming agent. FIGS. 8, 9 (Right), and 10 (Right) show the characteristic pores of the cast electrodes whether it is non-foamed or foamed. The higher magnification images in FIGS. 9 (Right) and 10 (Right) reveal the porosity in the foamed electrodes. The pores formed with 3% of the first foaming agent are spherical and have heterogenous pore size distribution ranging from 20 μm to 100 μm, as also seen in the non-decorated silicon electrode in FIG. 3. The pores formed with 3% of the second foaming agent Agent Y are irregularly shaped and appear like channels.

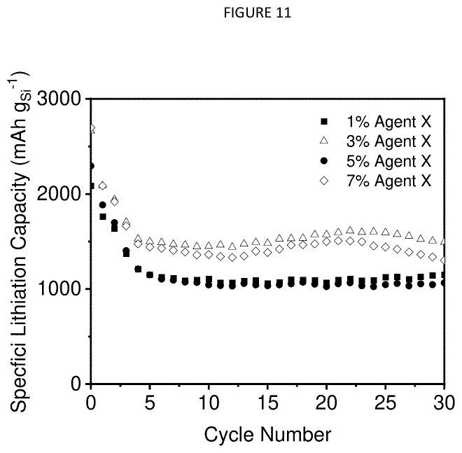

FIG. 11 presents a comparison of the half-cell electrochemical performance of the foamed silicon electrodes with 1%, 3%, 5%, and 7% of the first foaming agent. The data clearly shows variation in the specific gravimetric capacities of the electrodes as a function of the first foaming agent concentration, with the 3% and 7% first foaming agent electrodes exhibiting the higher specific gravimetric capacities compared to the foamed electrodes with 1% and 5% of the first foaming agent.

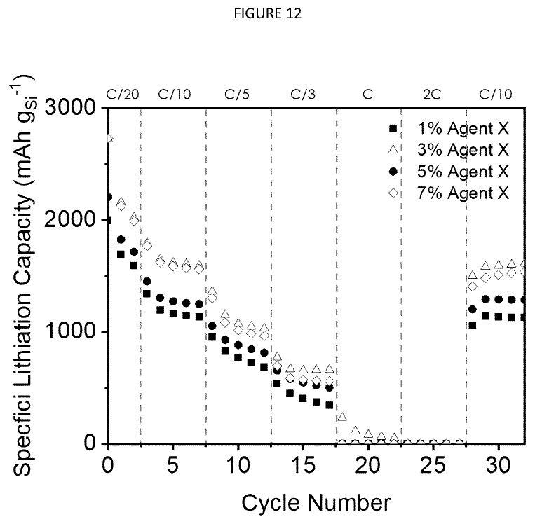

The half-cell rate performance of the silicon electrodes with 3% and 7% of the first foaming agent cycled at different C-rates are summarized in FIG. 12. The data clearly shows variation in the specific gravimetric capacities of the electrodes as a function of first foaming agent concentration. The data is consistent with single rate performance in FIG. 11, wherein the foamed electrodes with 3% and 7% of the first foaming agent exhibit the highest specific gravimetric capacities across all the C-rates tested.

The foamed metal-decorated silicon electrodes were incorporated into a half cell configuration battery using lithium metal as the counter electrode. The cells were cycled 3 times at C/20 (full lithiation/delithiation over 20 hours) followed by longer cycling at C/3 (full lithiation/delithiation over 3 hours).

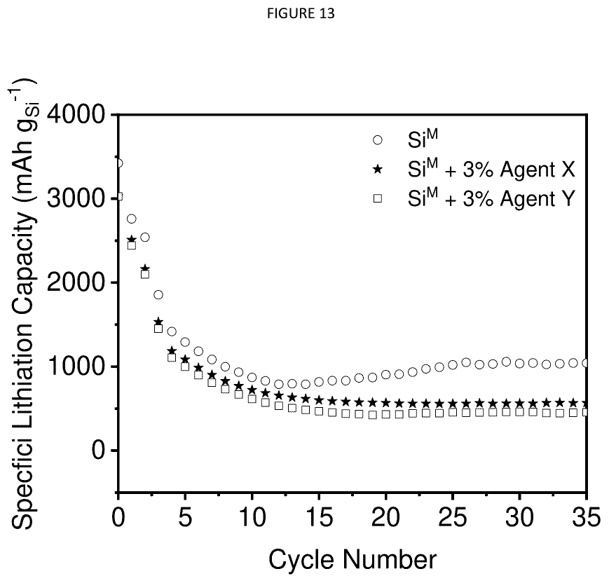

FIG. 13 shows a comparison of the half-cell electrochemical performance of metal-decorated silicon without a foaming agent and with 3% of the first foaming agent and 3% of the second foaming agent. The data show very similar electrochemical behavior of the electrodes with the first and second foaming agents, which both exhibit lower capacities compared to the non-foamed Si^{M}, although the foamed electrodes have much higher mass loading (˜1.34 mg cm⁻² for the foamed electrodes vs ˜0.69 mg cm⁻² for the non-foamed electrodes). The capacities of the foamed metal-decorated silicon electrodes are expected to be higher than the non-foamed electrode with similar mass loadings.

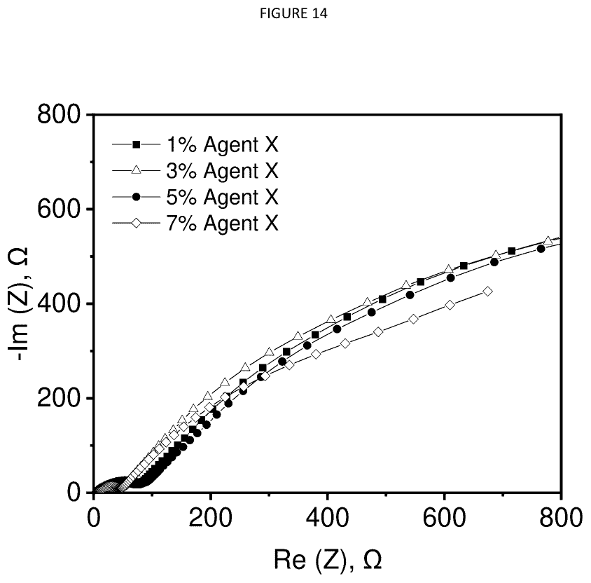

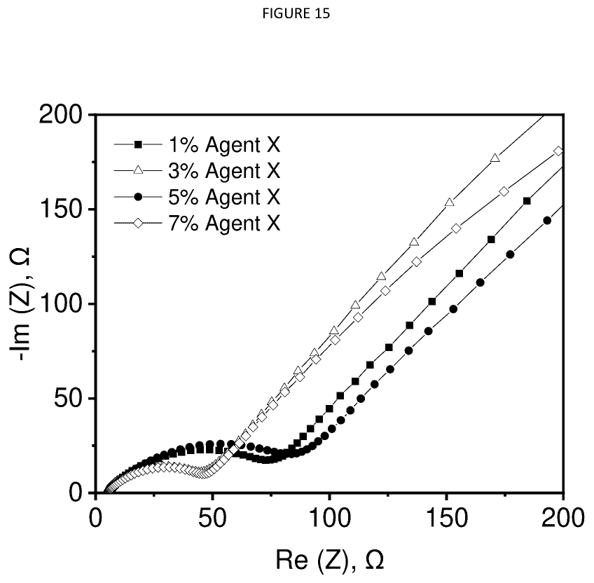

The electrochemical impedance spectroscopy data of the half cells prepared with foamed silicon electrodes after the formation cycles at C/20 are presented in FIGS. 14 and 15 in the form of Nyquist plots. The data show that the concentration of the first foaming agent affects the impedance of the cells, where 3% and 7% of the first foaming agent show the lowest resistance based on the diameter of the semicircle at high (10 kHz) to mid (˜35 Hz) frequency region. At the low frequency region (˜0.1 Hz to 20 mHz), the electrode with 7% Agent displays a smaller impedance compared to the other electrodes. The data also indicate that there is no direct correlation between the concentration of the foaming agent and the impedance of the cells, which is consistent with the electrochemical cycling behavior.

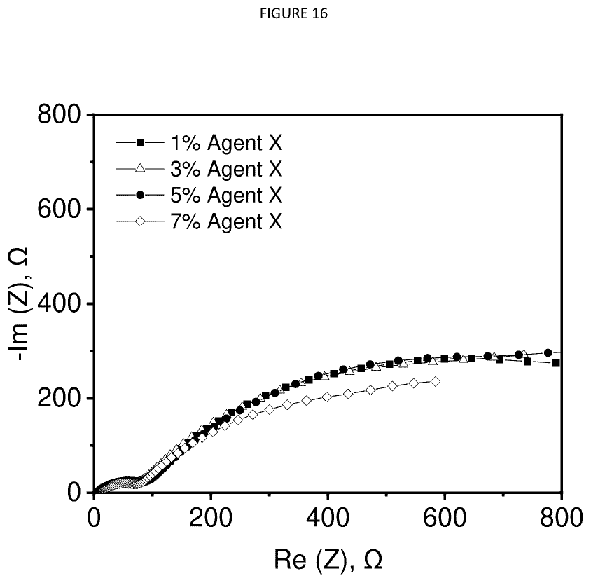

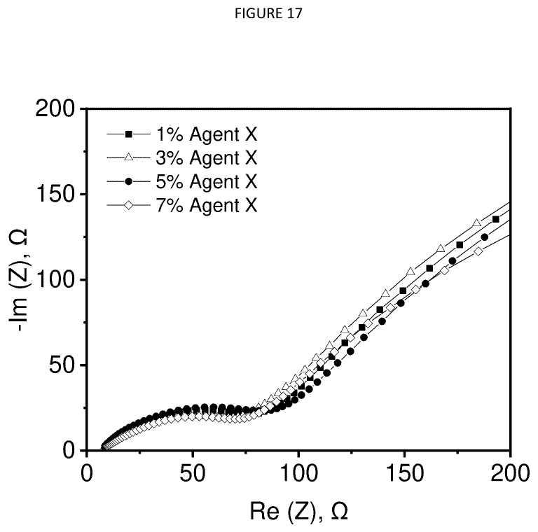

The electrochemical impedance spectroscopy data of the half cells prepared with foamed silicon electrodes after 20 cycles at C/3 are presented in FIGS. 16 and 17 in the form of Nyquist plots. The data indicate that the impedance of the cells is changing upon cycling of the batteries when compared with the Nyquist plots obtained just after the formation steps in FIGS. 14 and 15. After 20 cycles at C/3, the impedance of the cells at the high (10 kHz) to mid (˜35 Hz) frequency region data do not show obvious differences, although the electrode with 7% foaming Agent X exhibit a smaller low frequency impedance compared to the electrodes with 1%, 3%, and 5% of the first foaming agent.

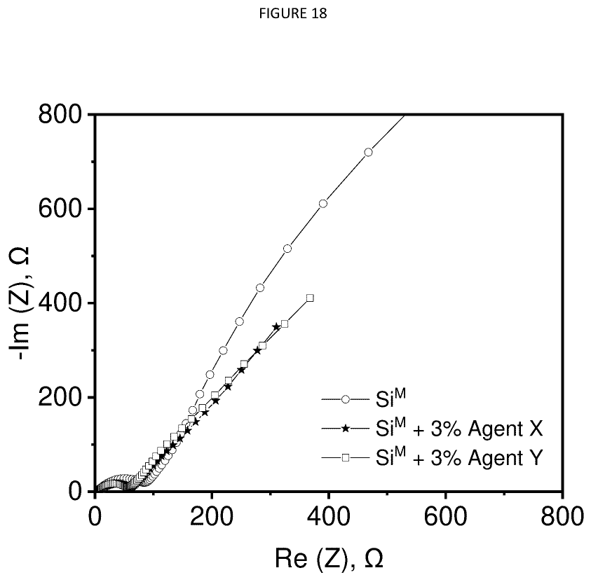

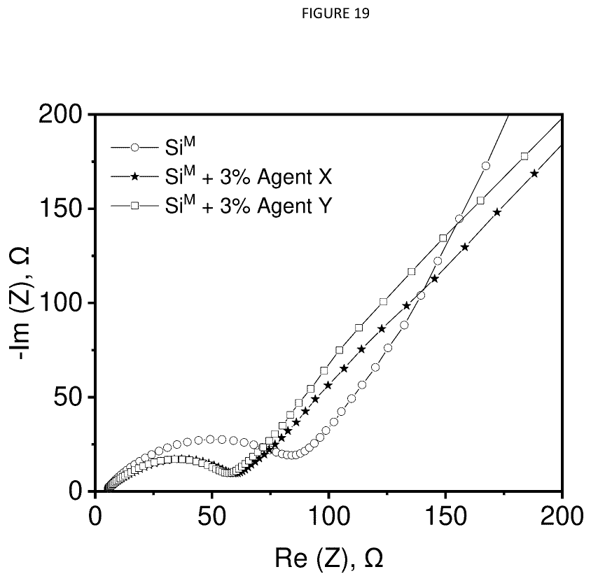

The electrochemical impedance spectroscopy data of the half cells prepared with foamed metal-decorated silicon electrodes after the formation cycles at C/20 are presented in FIGS. 18 and 19 in the form of Nyquist plots. The data show that the addition of 3% of the first foaming agent and 3% of the second foaming agent lowers the impedance of the cells as can be observed from the smaller semicircle at the high (10 kHz) to mid (˜35 Hz) frequency region as well as the different slope of the diffusion regime in the low frequency region (<35 Hz down to 20 mHz).

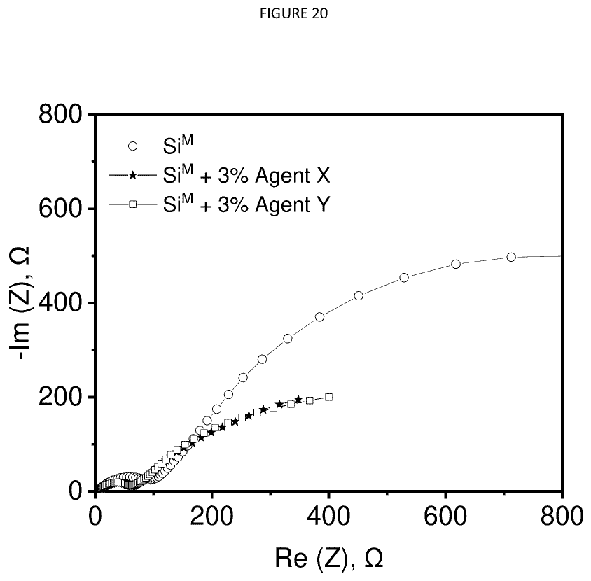

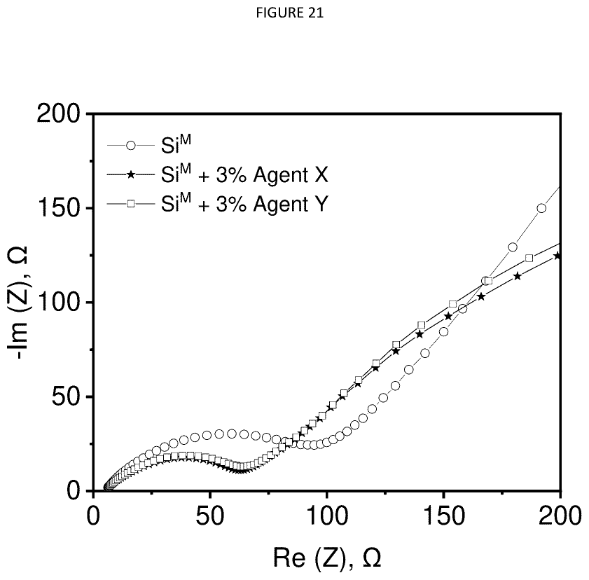

The electrochemical impedance spectroscopy data of the half cells prepared with foamed metal-decorated silicon electrodes after 20 cycles at C/3 are presented in FIGS. 20 and 21 in the form of Nyquist plots. The data indicate that the impedance of the cells is changing upon cycling of the batteries when compared with the Nyquist plots obtained just after the formation steps in FIGS. 17 and 18, especially the non-foamed electrode as can be seen from the changes in the high (10 kHz) to mid (˜35 Hz) frequency region. At the low frequency region (<35 Hz down to 20 mHz), all electrodes display changes in the slope of the diffusion part of the Nyquist plot, although the electrodes with the first foaming agent and the second foaming agent still display smaller impedance compared to the non-foamed electrodes.

### EXAMPLE 2

Various foamed cathodes were prepared as follows:

Generally: the foamed cathodes based on a Lithium transition metal oxide active material in a fashion analogous to that described for the anode materials. The same process can be employed for intercalation, or conversion based active materials for solid-state battery composite cathode fabrication. After the activation of the cathode films by vacuum drying over night at 90° C. and annealing in argon atmosphere at 350° C. for 1 hour at 10° C. min⁻¹ ramp rate, the cathode films are punched out to the required dimension. Controlled amount of antiperovskite solid electrolyte is deposited on top of the cathode films. The antiperovskites are synthesized by solid-state synthesis method to achieve the general formula of Li2OHX (where X=Cl, Br, F, I, etc. and combinations thereof). The cathode films along with the antiperovskite solid electrolyte are heated to temperatures ranging from 200-400° C. depending of the variant of the antiperovskite used. On doing this, the solid electrolyte material melts and diffuses itself into the pores of the foamed electrode structure. Once this process is completed, the infiltrated cathode films are quenched to room temperature to allow recrystallization of the melted solid electrolyte.

Foamed cathode electrodes were fabricated using a weight ratio of 89% Lithium nickel manganese cobalt oxide (NMC 811 or NMC 622.) 5% carbon black (C45), and 6% polyimide binder (P84). The polyimide binder was pre-dissolved in n-methyl pyrrolidone (NMP) solvent in 10 wt % ratio of P84 in NMP. The binder solution and excess NMP for viscosity adjustment were placed in a mixing jar with the mixing media, followed by the addition of the solid components. The electrode components were mixed using a low energy mixer until a homogeneous slurry is obtained. The foaming agent, Agent X, was added in 5%, 10%, 20% and 30 wt % concentrations and mixed with the slurry. The slurry with the foaming agent was cast onto an aluminum current collector and dried until the NMP solvent is removed. The prepared electrodes were heated treated in argon at 350° C. for one hour to cure the polyimide binder. The antiperovskite can be infiltrated after curing or in-situ with the infiltration.

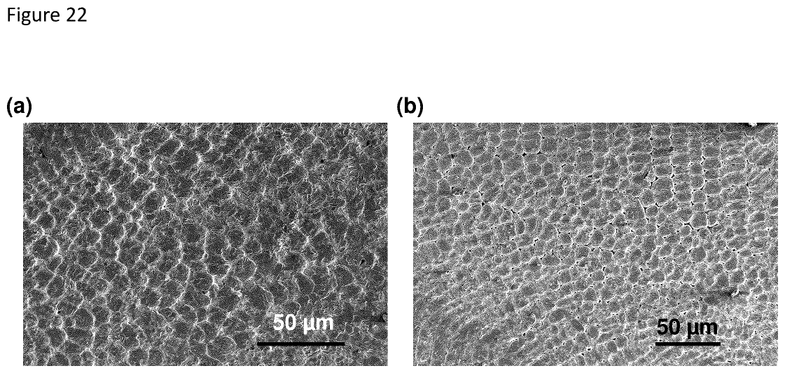

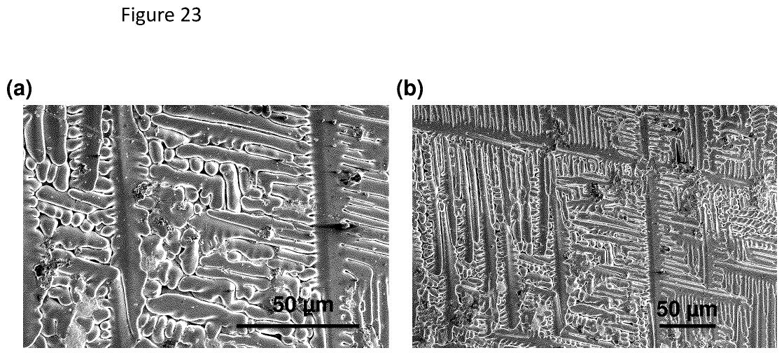

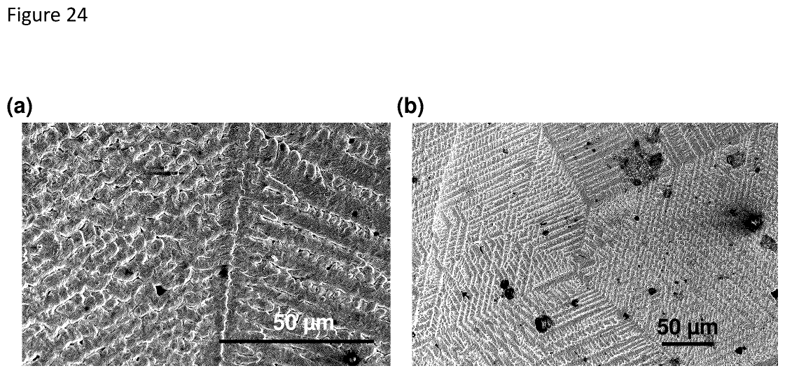

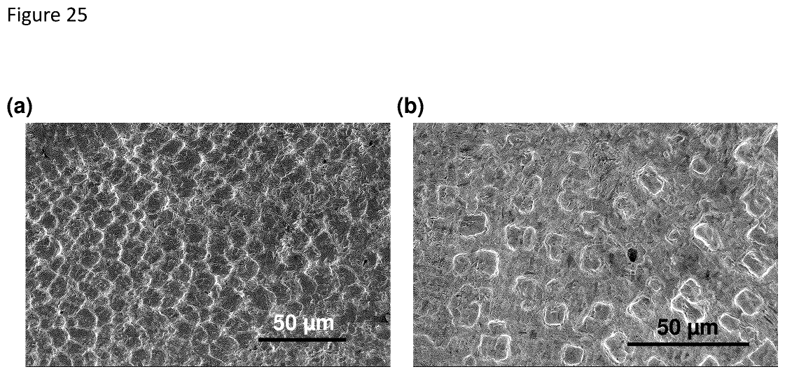

For infiltration in Example 2: a piece of the foamed cathode was cut and kept on a hotplate and heated to temperatures ranging between 200° C. and 300° C. Subsequently, known amounts of antiperovskite powder (LiOHCl, LiOHBr, LiOHClBr) were deposited on top of the cut foamed cathode piece using a spatula. After the powders were completely melted, the infiltrated films were removed from the hotplate and the films were imaged using SEM, as seen in FIGS. 22, 23, 24, and 25. FIGS. 22(a), 23(a), 24(a), and 25(a) employed foaming Agent X at 5 wt % whereas FIGS. 22(a), 23(a), 24(a), and 25(a) employed foaming Agent X at 10 wt %. As seen in these Figures for the cathode, increases in the amount of foaming agent increased the number and yield of pores in the foamed electrode. FIGS. 22 to 25 also clearly show the different architectures formed by the recrystallization of the solid antiperovskite electrolytes. It is believed that the morphology and microstructural difference of the recrystallized solid electrolyte significantly impacts the performance of the final solid-state battery. In addition to variations with halide group in the antiperovskite electrolytes, changed the composition of the foamed electrode substrate, with other observable differences in the resultant recrystallized microstructure of the solid electrolyte.

What is claimed is:

1. A method for making a foamed battery electrode comprising:
(i) providing a slurry comprising a binding agent, a solvent, an electrode component, a conductive additive, and a foaming agent;
(ii) casting the slurry onto a current collector;
(iv) removing the solvent; and
(v) heating the result of (iv) to cure the binder and obtain a foamed battery electrode.

2. The method of claim 1 wherein the slurry is prepared by combining the binding agent and the solvent; and adding the electrode component and the conductive additive to the combination.

3. The method of claim 2 wherein the foaming agent is added to the slurry comprising the binding agent, the solvent, the electrode component, and the conductive additive.

4. The method of Clam 1 wherein the binding agent is a polymer binder.

5. The method of claim 4 wherein the polymer binder is polyimide binder.

6. The method of claim 1 wherein the solvent is removed by drying.

7. The method of claim 1 wherein the solvent is a dielectric solvent.

8. The method of claim 7 wherein the dielectic solvent comprises N-methyl pyrollidone, water, ethanol, dimethyl formamide, xylene, or mixtures of any of the foregoing.

9. The method of claim 1 wherein the electrode component comprises an anode component or a cathode component.

10. The method of claim 10 wherein the anode component comprises silicon.

11. The method of claim 9 wherein the cathode component is comprised of nickel, manganese, and cobalt.

12. The method of claim 1 wherein the conductive additive comprises carbon black.

13. The method of claim 1 wherein the current collector comprises copper when the electrode component is an anode component; and comprises aluminum when the electrode component is a cathode component.

14. The method of claim 1 wherein the foaming agent comprises thermoplastic microspheres which contain a gas.

15. The method of claim 14 wherein the thermoplastic of the thermoplastic microspheres has a melt temperature less than the heat curing temperature of step (v), and wherein after step (v), the thermoplastic microspheres and the gas contained therein are substantially removed from the foamed battery electrode, the removal leaving behind pores therein.

16. The method of claim 1 wherein the slurry of (i) further comprises a redox active material.

17. The method of claim 16 wherein the redox active material is graphite.

18. The method of claim 1 wherein the electrode component is a cathode component, and wherein the method further comprises (vi) infiltrating a secondary conductor into the foamed battery electrode.

19. The method of claim 18 wherein the secondary conductor comprises at least an antiperovskite.

20. A foamed battery electrode made by the method of claim 1.

21. A lithium ion battery comprising a foamed battery electrode made by the method of claim 1.

22. The lithium ion battery of claim 21 further comprising a separator and an electrolyte.
